(19) United States
(12) Patent Application Publication
(10) Pub. No.: US 2017/0337273 A1
(43) Pub. Date: Nov. 23, 2017

(54) MEDIA FILE SUMMARIZER

(71) Applicant: OpenTV, Inc, San Francisco, CA (US)

(72) Inventors: Nandini Iyer, Fremont, CA (US); Gregory James Lundell, San Francisco, CA (US)

(21) Appl. No.: 15/157,034

(22) Filed: May 17, 2016

(51) Int. Cl. G06F 17/30

(52) U.S. Cl. CPC G06F 17/30843; G06F 17/30867; G06F 17/30106; G06F 17/30787; G06F 17/3082

(57) ABSTRACT

A summarizer machine can be configured provide a summary file of at least one episode of a media series. The summary file may be generated or otherwise provided based on one or more social media messages. The summarizer machine detects a request that the summary file be generated for a user, and the request may specify the episodes to be summarized. The machine accesses a media database that stores the episodes and also accesses a communication database that records communications among social connections of the requesting user. The communications all identify a same media scene in a same episode, and some of the communications all reference a same media frame in that media scene. The machine determines an excerpt of a media file for the episode and incorporates the excerpt into the generated summary file. The machine causes the summary file to be provided in response to the request.

### TECHNICAL FIELD

The subject matter disclosed herein generally relates to the technical field of special-purpose machines that process media data, including computerized variants of such special-purpose machines and improvements to such variants, and to the technologies by which such special-purpose machines become improved compared to other special-purpose machines that process media data. Specifically, the present disclosure addresses systems and methods that summarize one or more media files.

### BACKGROUND

A machine (e.g., a server computer) may be configured to interact with one or more users by accepting and responding to requests submitted by such users. For example, a machine can be configured as a search engine for a database, and the configured machine can provide search results retrieved from the database in response to search requests received from various users. As another example, a machine can be configured as a social networking server, and the configured machine can model social relationships between or among various users. In some situations, the social networking server is configured to monitor communications among such users.

### BRIEF DESCRIPTION OF THE DRAWINGS

Some embodiments are illustrated by way of example and not limitation in the figures of the accompanying drawings.

FIG. 1 is a network diagram illustrating a network environment suitable for operating a summarizer machine configured to summarize one or more media files, according to some example embodiments.

FIG. 2 is a block diagram illustrating components of the summarizer machine, according to some example embodiments.

FIG. 3 is a conceptual diagram illustrating episodes within seasons of a media series, according to some example embodiments.

FIG. 4 is a conceptual diagram illustrating media files that store the episodes of the media series, according to some example embodiments.

FIG. 5 is a block diagram illustrating the media files being stored by a media database, according to some example embodiments.

FIG. 6 is a block diagram illustrating communication records being stored by a communication database, according to some example embodiments.

FIG. 7 is a block diagram illustrating a user profile being stored in a social relationships database, according to some example embodiments.

FIGS. 8-13 are flowcharts illustrating operations of the summarizer machine in performing a method of generating a summary file for a user, according to some example embodiments.

FIG. 14 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate summarization of one or more media files, and example systems (e.g., special-purpose machines) are configured to facilitate summarization of one or more media files. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A machine (e.g., a summarizer machine) can be configured (e.g., by software modules) to interact with a user in generating and providing a summary (e.g., summary file) of at least one episode of a media series (e.g., “Mad Men®,” “Game of Thrones®, ” or “The Walking Dead®”). The summary may be generated based on one or more social media messages accessible by the machine. As configured, the machine detects a request that a summary file be generated for a user, and the request may specify a set of episodes to be summarized. In some example embodiments, the desired duration of the summary is specified in the request. The machine accesses a media database that stores the episodes to be summarized and also accesses communication records stored in a communication database that tracks communications among a group of users whose social relationships to the requesting user are modeled by a social relationships database (e.g., a social graph maintained by a social networking system, such as Twitter®, Facebook®, or Instagram®). These accessed communication records each identify a same media scene in a same episode to be summarized, and a portion of these communication records all reference a same media frame in that media scene.

The machine determines an excerpt of the media file that stores the episode and generates the summary file to include the excerpt. The determination of the excerpt may be based on one or more degrees of social closeness between the user and the different users in the group of users. The machine then causes the generated summary file to be provided to the user in response to the request. Additional details are provided below.

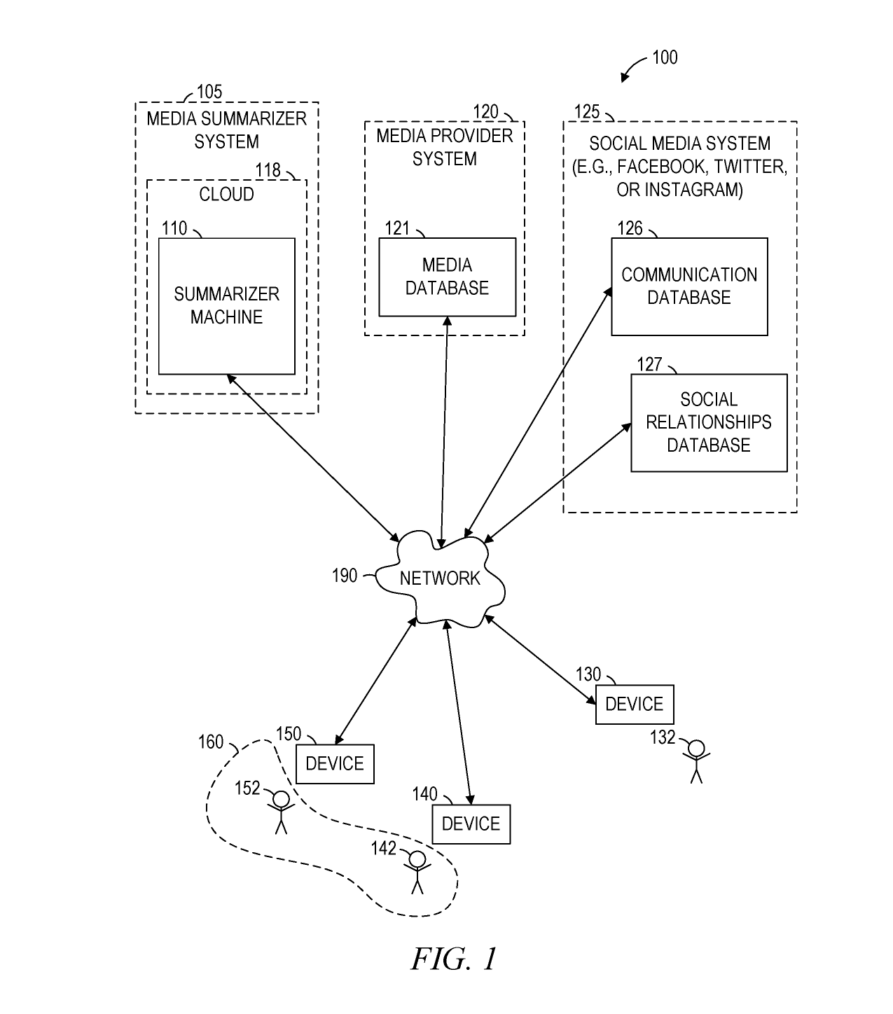

FIG. 1 is a network diagram illustrating a network environment 100 suitable for operating a summarizer machine 110 that is configured to summarize one or more media files, according to some example embodiments. The network environment 100 includes the summarizer machine 110, a media database 121, a communication database 126, a social relationships database 127, and devices 130, 140, and 150, all communicatively coupled to each other via a network 190.

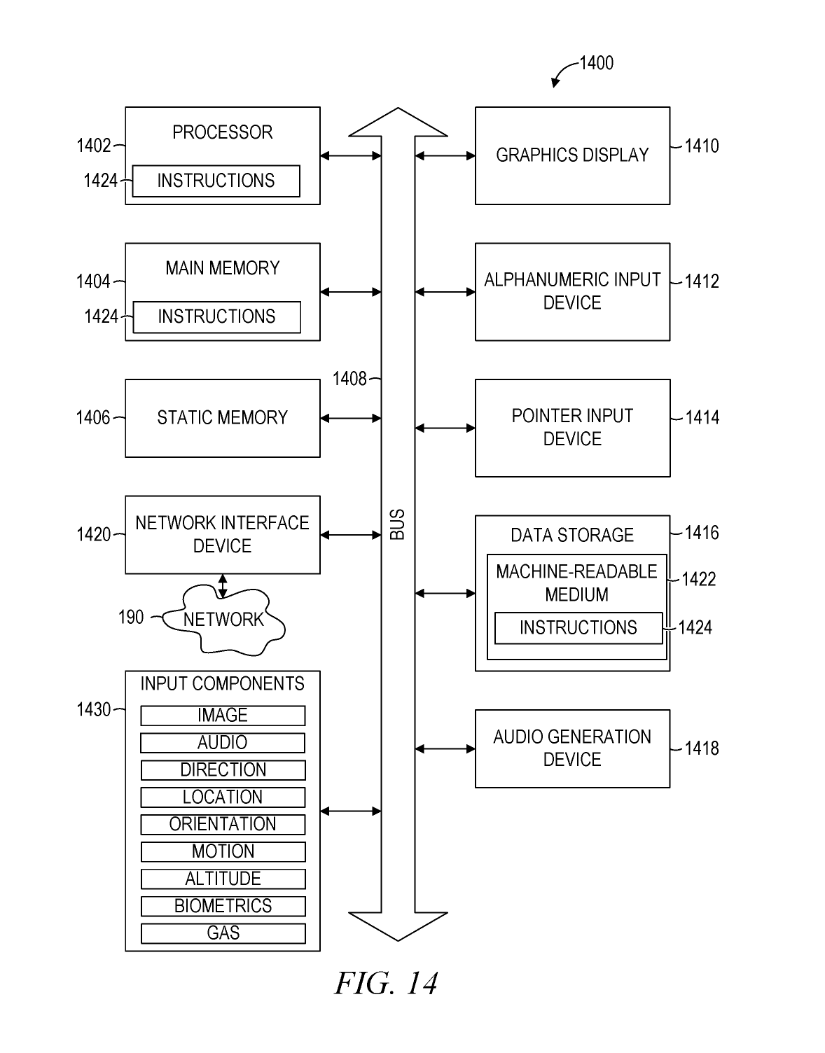

The summarizer machine 110 may form all or part of a cloud 118 (e.g., a geographically distributed set of multiple machines configured to function as a single server), which may form all or part of a media summarizer system 105 (e.g., a cloud-based server system configured to provide one or more network-based media summarizing services to the devices 130, 140, and 150). The media database 121 may form all or part of a media provider system 120 (e.g., a cloud-based server system configured to provide one or more episodes of one or more media series to the devices 130, 140, and 150). The communication database 126, the social relationships database 127, or both may form all or part of a social media system 125 (e.g., a cloud-based server system configured to provide one or more social media services or other social networking services to various users). Examples of the social media system 125 include server systems for Twitter®, Facebook®, and Instagram®. The summarizer machine 110, the media database 121, the communication database 126, the social relationships database 127, and the devices 130, 140, and 150 may each be implemented in a special-purpose (e.g., specialized) computer system, in whole or in part, as described below with respect to FIG. 14.

Also shown in FIG. 1 are users 132, 142, and 152. One or more of the users 132, 142, and 152 may be a human user (e.g., a human being), a machine user (e.g., a computer configured by a software program to interact with the device 130, 140, or 150), or any suitable combination thereof (e.g., a human assisted by a machine or a machine supervised by a human). The user 132 is associated with the device 130 and may be a user of the device 130. As examples, the device 130 may be a desktop computer, a vehicle computer, a tablet computer, a navigational device, a portable media device, a smart phone, or a wearable device (e.g., a smart watch, smart glasses, smart clothing, or smart jewelry) belonging to the user 132.

Similarly, the user 142 is associated with the device 140 and may be a user of the device 140. Hence, the device 140 may be a desktop computer, a vehicle computer, a tablet computer, a navigational device, a portable media device, a smart phone, or a wearable device belonging to the user 142. Likewise, the user 152 is associated with the device 150 and may be a user of the device 150. Accordingly, the device 150 may be a desktop computer, a vehicle computer, a tablet computer, a navigational device, a portable media device, a smart phone, or a wearable device belonging to the user 152. In addition, the users 142 and 152 may form all or part of a group 160 of users whose social relationships (e.g., as friends, followers, or connections of various degrees of closeness) to the user 132 are modeled by the social relationships database 127.

Any of the systems or machines (e.g., databases and devices) shown in FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 14, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single machine, and the functions described herein for any single system or machine may be subdivided among multiple systems or machines.

The network 190 may be any network that enables communication between or among systems, machines, databases, and devices (e.g., between the summarizer machine 110 and the device 130, or among the summarizer machine 110 and one or more of the media database 121, the communication database 126, and the social relationships database 127). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

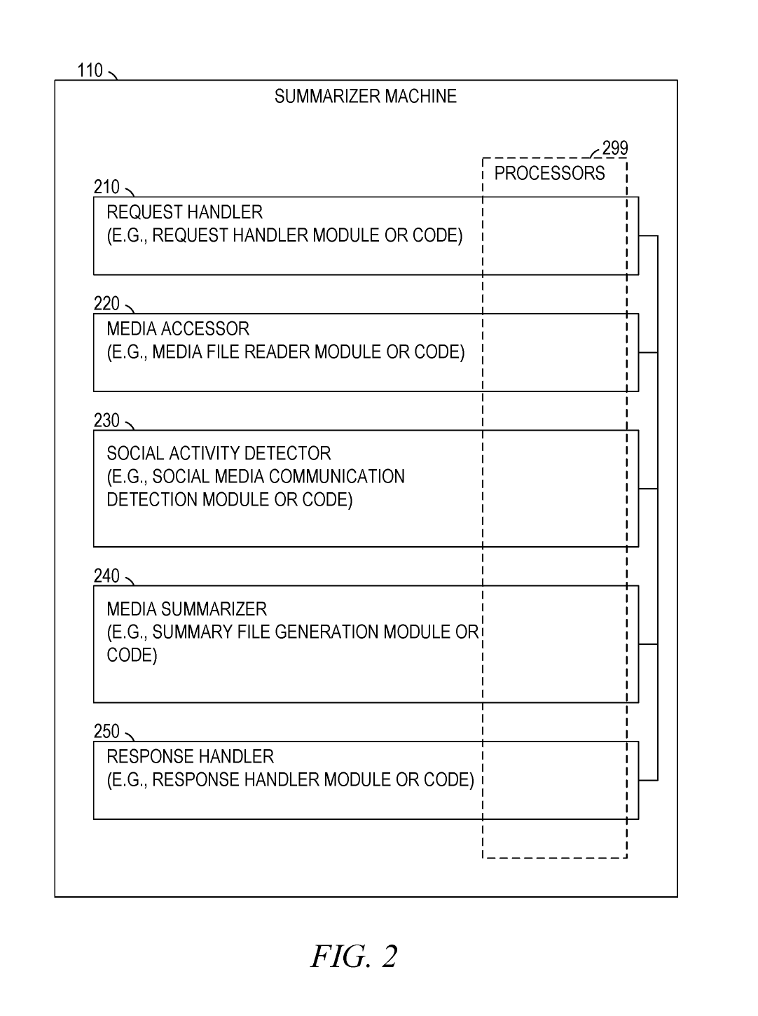

FIG. 2 is a block diagram illustrating components of the summarizer machine 110, according to some example embodiments. The summarizer machine 110 is shown as including a request handler 210 (e.g., in the example form of a request handler module or code), a media accessor 220 (e.g., in the example form of a media file reader module or code), a social activity detector 230 (e.g., in the example form of a social media communication detection module or code), a media summarizer 240 (e.g., in the example form of a summary file generation module or code), and a response handler 250 (e.g., in the example form of a response handler module or code), all configured to communicate with each other (e.g., via a bus, shared memory, or a switch).

In various example embodiments, one or more of the request handler 210, the media accessor 220, the social activity detector 230, the media summarizer 240, and the response handler 250 form all or part of an application (e.g., a mobile app) that is stored (e.g., installed) on the summarizer machine 110. Furthermore, one or more processors 299 (e.g., hardware processors, digital processors, or any suitable combination thereof) may be included (e.g., temporarily or permanently) in the request handler 210, the media accessor 220, the social activity detector 230, the media summarizer 240, the response handler 250, or any suitable combination thereof.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

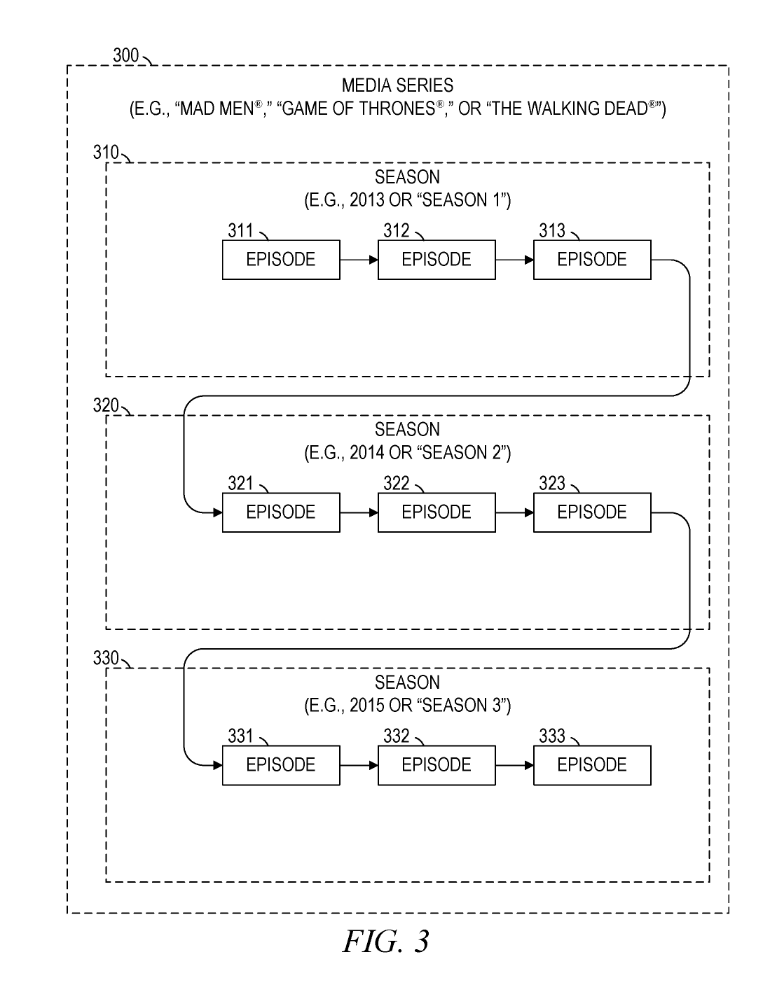

FIG. 3 is a conceptual diagram illustrating a media series 300, according to some example embodiments. The media series 300 is a body of episodic media content (e.g., “Mad Men®, ” “Game of Thrones®,” or “The Walking Dead®”) that may span one or more seasons 310, 320, and 330. For example, the season 310 may be a 2013 season (e.g., titled “Season 1”) of the media series 300. As shown in FIG. 3, the season 310 includes one or more episodes 311, 312, and 313, which may be sequential episodes, as indicated by arrows in FIG. 3. As another example, the season 320 may be a 2014 season (e.g., titled “Season 2”) of the media series 300. As shown in FIG. 3, the season 320 includes one or more episodes 321, 322, and 323, which may also be sequential episodes, as indicated by arrows in FIG. 3. As a further example, the season 330 may be a 2015 season (e.g., titled “Season 3”) of the media series 300. As shown in FIG. 3, the season 330 includes one or more episodes 331, 332, and 333, which may further be sequential episodes, as indicated by arrows in FIG. 3. Furthermore, as indicated by arrows in FIG. 3, the seasons 310, 320, and 330 may be sequential seasons of the media series 300.

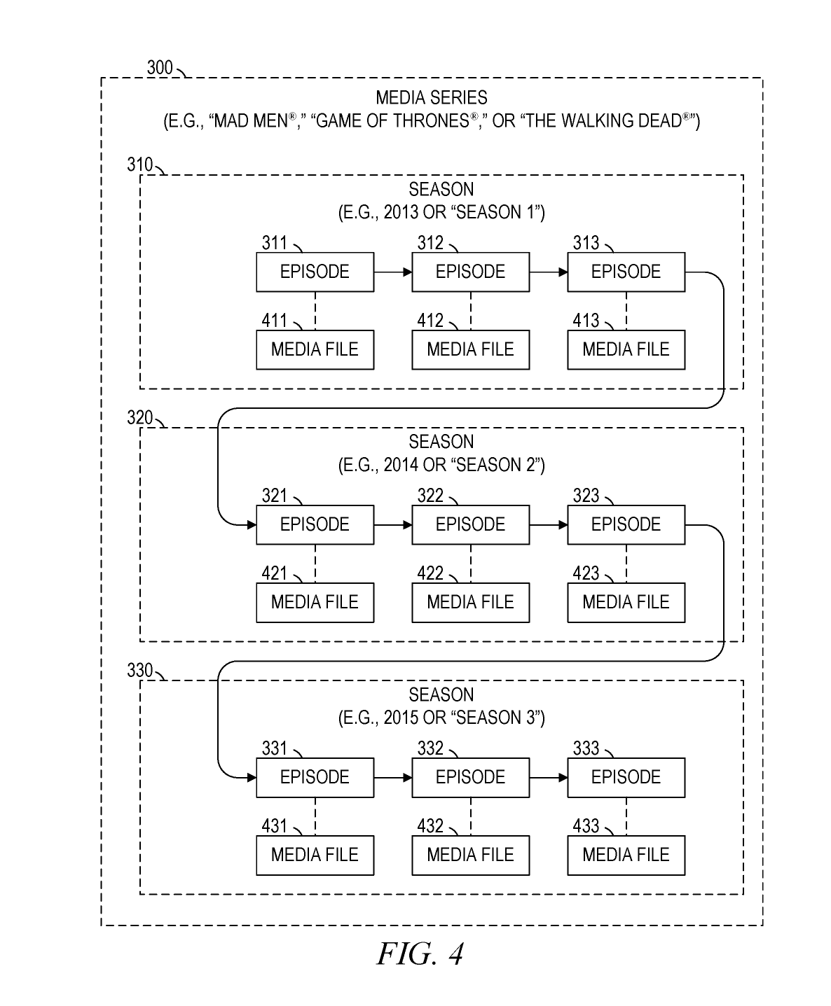

FIG. 4 is a conceptual diagram illustrating media files 411, 412, 413, 421, 422, 423, 431, 432, and 433 that respectively store the episodes 311, 312, 313, 321, 322, 323, 331, 332, and 333 of the media series 300, according to some example embodiments. Any one or more of the media files 411-433 stores or otherwise includes audio data, video data, text data (e.g., closed captioning or subtitles), or any suitable combination thereof

As shown in FIG. 4, within the season 310, the episode 311 corresponds to the media file 411 and is stored or otherwise represented by the media file 411; the episode 312 corresponds to the media file 412 and is stored or otherwise represented by the media file 412; and the episode 313 corresponds to the media file 413 and is stored or otherwise represented by the media file 413. Similarly, within the season 320, the episode 321 corresponds to the media file 421 and is stored or otherwise represented by the media file 421; the episode 322 corresponds to the media file 422 and is stored or otherwise represented by the media file 422; and the episode 323 corresponds to the media file 423 and is stored or otherwise represented by the media file 423. Likewise, within the season 330, the episode 331 corresponds to the media file 431 and is stored or otherwise represented by the media file 431; the episode 332 corresponds to the media file 432 and is stored or otherwise represented by the media file 432; and the episode 333 corresponds to the media file 433 and is stored or otherwise represented by the media file 433.

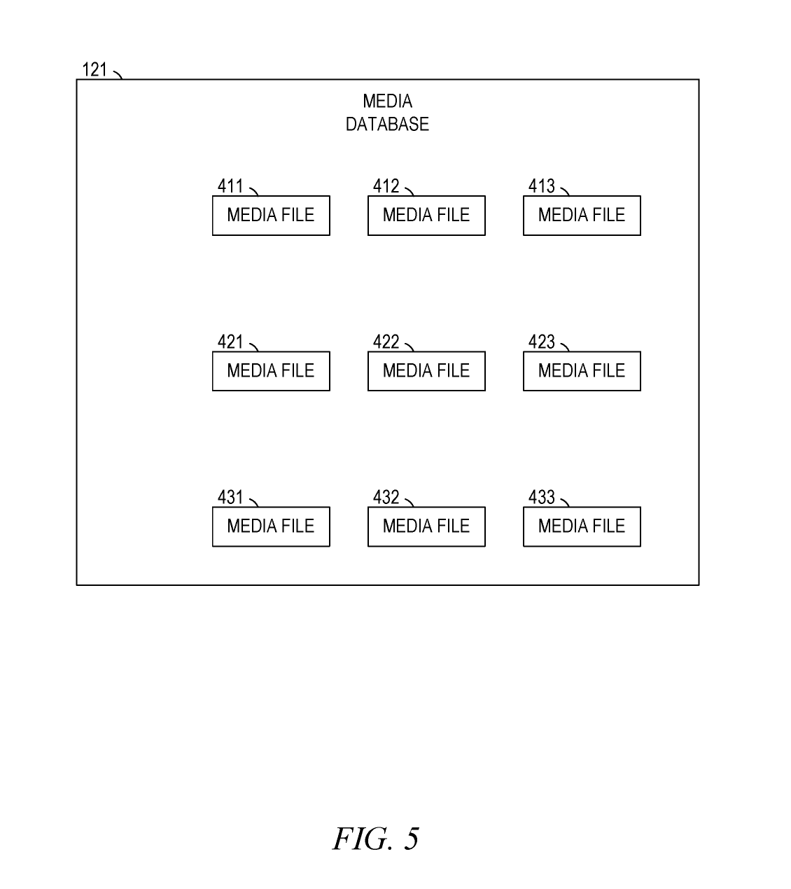

FIG. 5 is a block diagram illustrating the media files 411-433 being stored by the media database 121 (e.g., within the media provider system 120), according to some example embodiments. According to various example embodiments, the media database 121 is configured to provide the summarizer machine 110 with access to any one or more of the media files 411-433 or to any one or more portions thereof. Each of the media files 411-433 stores a corresponding different episode (e.g., episode 311-333 respectively) of the media series 300. In addition, each of the media files 411-433 includes media frames (e.g., audio frames, video frames, text, or any suitable combination thereof) that each have a different timecode in that media file (e.g., a timecode that is unique within that media file). Such a timecode may be expressed in hours, minutes, seconds, and sequential frame numbers (e.g., with additional field numbers, in the case of interlaced media formats; with additional right-or-left eye indicators, in the case of stereoscopic media formats; or with both).

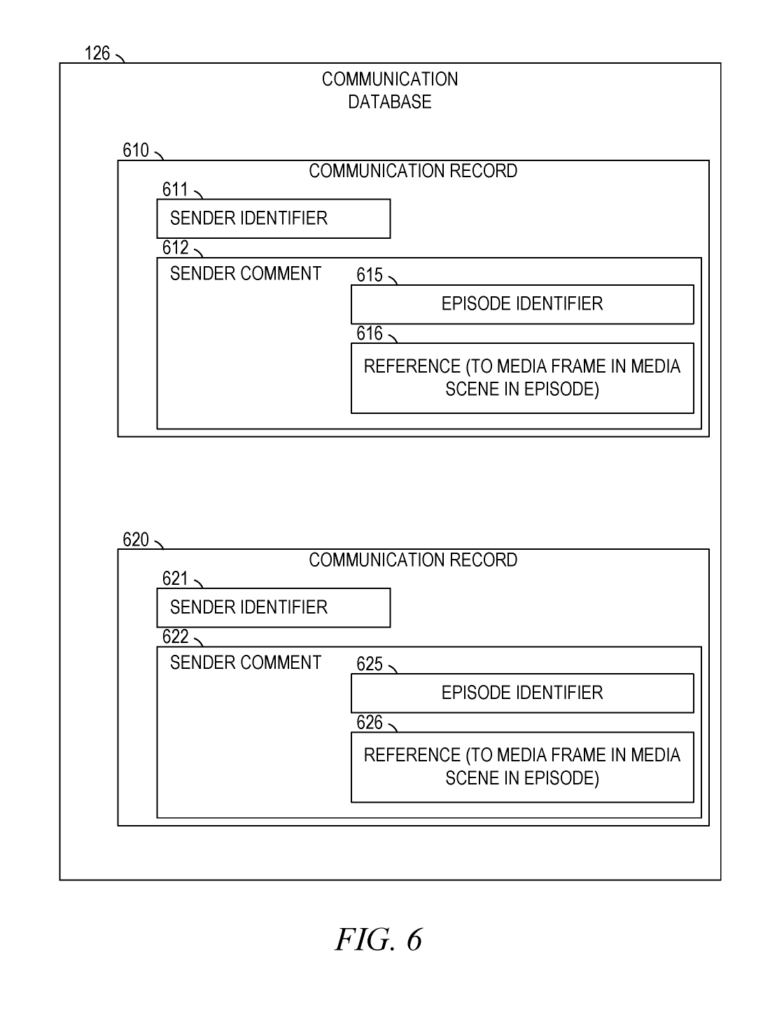

FIG. 6 is a block diagram illustrating communication records 610 and 620 being stored by the communication database 126 (e.g., within the social media system 125), according to some example embodiments. Typically, the communication database 126 stores many communication records (e.g., tracking communications among the users 132, 142, and 152 over a period of time, such as several months). For clarity, however, only two communication records 610 and 620 are shown in FIG. 6.

In the example shown in FIG. 6, the communication record 610 is a record of a communication sent from a sender user (e.g., the user 142) to a receiver user (e.g., the user 152). The communication record 610 includes a sender identifier 611 that identifies the sender user (e.g., by username or other user identifier) and a sender comment 612 that includes some or all of the information contained in the communication from the sender user (e.g., the user 142) to the receiver user (e.g., the user 152). As shown in FIG. 6, the sender comment 612 includes an episode identifier 615 that identifies an episode (e.g., the episode 311) of the media series 300. The sender comment 612 also includes a reference 616 to a media frame in a media scene within the episode identified by the episode identifier 615.

Similarly, as shown in FIG. 6, the communication record 620 is another record that records a different communication sent from a sender user (e.g., the user 152) to a receiver user (e.g., the user 142). The communication record 620 includes its own sender identifier 621 that identifies the sender user for the communication record 620 (e.g., by username or other user identifier). The communication record 620 also includes a sender comment 622 that includes some or all of the information contained in the communication from the sender user (e.g., the user 152) to the receiver user (e.g., the user 142). As shown in FIG. 6, the sender comment 622 includes an episode identifier 625 that identifies an episode (e.g., the episode 311) of the media series 300. The sender comment 622 also includes a reference 626 to a media frame in a media scene within the episode identified by the episode identifier 625. In many situations, the episode identifiers 615 and 625 both identify the same episode (e.g., episode 311) in the media series 300. Also, in many situations, the references 616 and 626 both reference the same media frame (e.g., at the same timecode) in the same media scene in the episode (e.g., episode 311) identified by the episode identifiers 615 and 625.

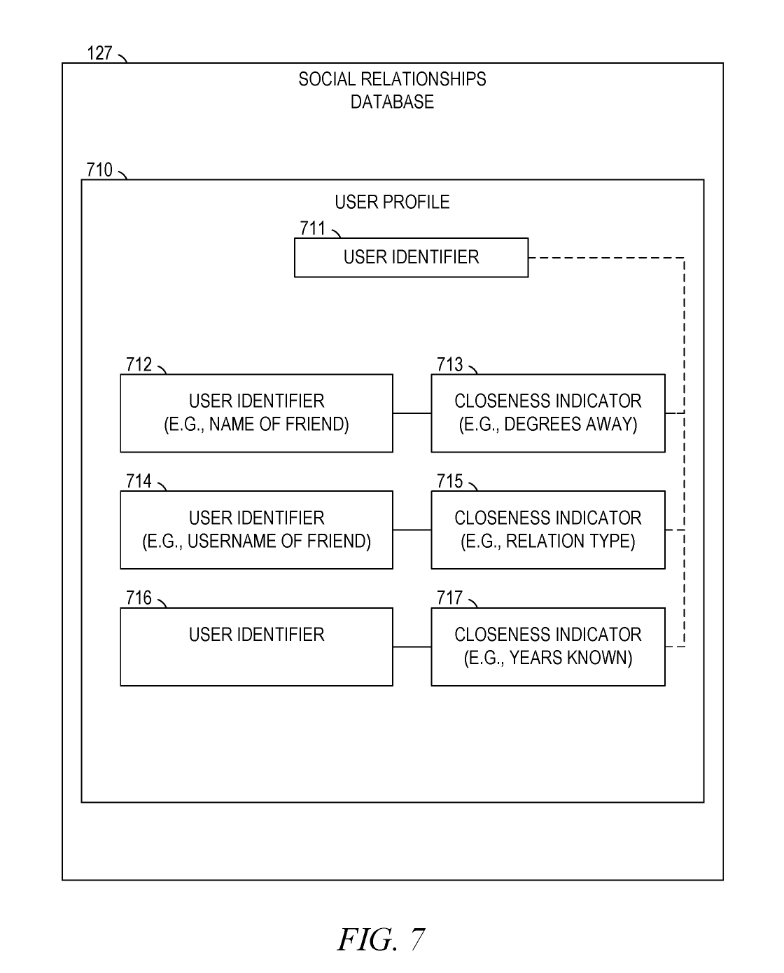

FIG. 7 is a block diagram illustrating a user profile 710 being stored in the social relationships database 127 (e.g., within the social media system 125), according to some example embodiments. In the example embodiments shown in FIG. 7, the user profile 710 corresponds to the user 132 (e.g., a person for whom a summary of one or more episodes of the media series 300 is to be generated) and includes a user identifier 711 that identifies the user 132 (e.g., by username or other user identifier that may be unique within the social relationships database 127). The user profile 710 may form all or part of a data structure by which social relationships of the user 132 are modeled by the social relationships database 127.

As shown in FIG. 7, the user profile 710 includes additional user identifiers 712, 714, and 716 and respectively corresponding closeness indicators 713, 715, and 717. The closeness indicator 713 indicates (e.g., quantifies) a degree of social closeness between the entity identified by the user identifier 712 (e.g., the user 142) and the entity identified by the user identifier 711 (e.g., the user 132). Similarly, the closeness indicator 715 indicates a degree of social closeness between the entity identified by the user identifier 714 (e.g., the user 152) and the entity identified by the user identifier 711 (e.g., the user 132). Likewise, the closeness indicator 717 indicates a degree of social closeness between the entity identified by the user identifier 716 (e.g., a further friend of the user 132) and the entity identified by the user identifier 711 (e.g., the user 132).

Specifically, in the example embodiments shown in FIG. 7, the user identifier 712 (e.g., a name or other identifier of a friend, relative, colleague, or acquaintance of the user 132, such as the user 142) corresponds to the closeness indicator 713 (e.g., a count of degrees of social distance separating the user 142 from the user 132). Similarly, the user identifier 714 (e.g., a username or other identifier of a friend, relative, colleague, or acquaintance of the user 132, such as the user 152) corresponds to the closeness indicator 715 (e.g., a relation type, relationship category, or other relationship descriptor, such as “immediate family,” “member of household,” “extended family,” “friend,” “current coworker,” or “former coworker”). Likewise, the user identifier 716 corresponds to the closeness indicator 717 (e.g., an age of the relationship between the user 132 and the user identified by the user identifier 716, for example, expressed as a count of years). To model the social relationships of the user 132, the user profile 710 may include additional pairs of user identifiers (e.g., similar to the user identifiers 712, 714, and 716) and closeness indicators (e.g., similar to the closeness indicators 713, 715, and 717). In some example embodiments, the user profile 710 may form all or part of a social graph that models relationships among multiple users of a social networking service (e.g., Twitter®, Facebook®, or Instagram®).

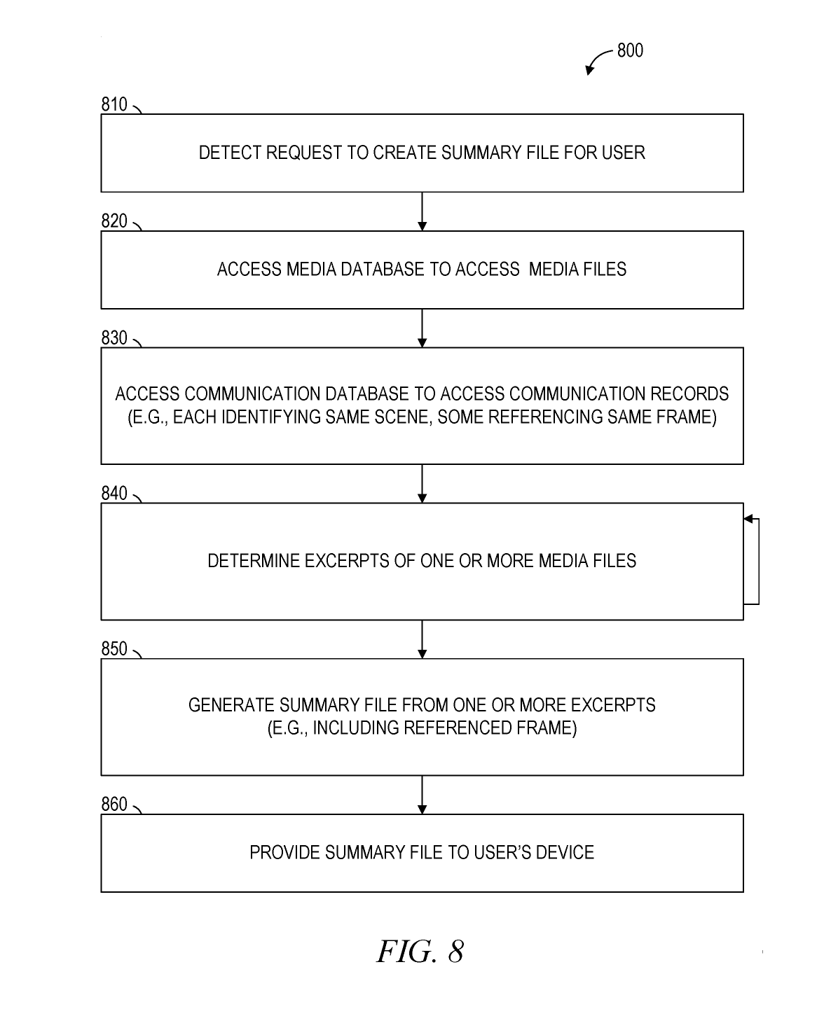

FIGS. 8-13 are flowcharts illustrating operations of the summarizer machine 110 in performing a method 800 of generating a summary file for the user 132, according to some example embodiments. Operations in the method 800 may be performed by the summarizer machine 110, using components (e.g., modules) described above with respect to FIG. 2, using one or more processors (e.g., microprocessors or other hardware processors), or using any suitable combination thereof. As shown in FIG. 8, the method 800 includes operations 810, 820, 830, 840, 850, and 860.

In operation 810, the request handler 210 detects a request that a summary file be generated for the user 132. In some example embodiments, the request specifies a set of one or more episodes (e.g., the episode 311, among other episodes) of media content (e.g., one or more of the seasons 310, 320, and 330 of the media series 300) to be summarized by the summary file.

In operation 820, the media accessor 220 accesses the media database 121. As noted above, the media database 121 stores the media files 411-433, which include the media files (e.g., the media file 411) corresponding to the requested episodes (e.g., episode 311). Accordingly, the media accessor 220 accesses the media files for the requested episodes by performing operation 820.

In operation 830, the social activity detector 230 accesses the communication database 126. As noted above, the communication database 126 stores communication records (e.g., the communication records 610 and 620) among the group 160 of users (e.g., users 142 and 152) whose social relationships to the user 132 are modeled by the social relationships database 127. Each of the records accessed in operation 830 identifies the same episode (e.g., an episode, such as the episode 311, that is identified both by the episode identifier 615 in the communication record 610 and by the episode identifier 625 in the communication record 620). Furthermore, a portion of the records accessed in operation 830 identify the same media scene by virtue of referencing a same media frame (e.g., a same media frame that is referenced both by the reference 616 in the communication record 610 and by the reference 626 in the communication record 620) within that same episode (e.g., their common episode). In the example embodiments illustrated in FIG. 8, the records accessed in operation 830 identify the episode 311 in the media series 300.

In operation 840, the media summarizer 240 determines (e.g., extracts, selects, chooses, defines, or otherwise identifies) an excerpt of media file 411 for the episode 311 in the media series 300. This determination is based on (e.g., responsive to) the fact that the episode 311 was identified by the records accessed in operation 830, and operation 840 may include detecting that the episode 311 is identified by the records accessed in operation 830. The media summarizer 240 determines the excerpt such that the excerpt includes the media frame (e.g., referenced media frame) referenced by the portion of the records accessed in operation 830 (e.g., the media frame referenced by the references 616 and 626 in the communication database 126). Specifically, the excerpt is defined by a start timecode and a stop timecode that surround a timecode of the media frame referenced by the portion of the records. For example, the start timecode may precede the timecode of the referenced media frame by ten seconds, thirty seconds, or one minute, and the stop timecode may follow the timecode of the referenced media frame by two seconds, eight seconds, or twenty seconds. According to various example embodiments, operation 840 may be repeated to determine one or more additional excerpts of the episode 311 or one or more additional excerpts of other requested episodes, for inclusion in the summary file to be generated for the user 132.

In operation 850, the media summarizer 240 generates the requested summary file for the user 132. The generation of the summary file is based on the excerpt determined in operation 840. In particular, the generated summary file includes the excerpt determined in operation 840. According to various example embodiments, one or more additional excerpts determined in various repetitions of operation 840 are also included in the generated summary file that results from operation 850. In some example embodiments, the summary file is itself a media file (e.g., a video file), and the summary file may be played by a playback device (e.g., the device 130) to present some or all of the one or more excerpts determined in operation 840. In alternative example embodiments, the summary file contains no actual media content but includes metadata (e.g., start timecode, stop timecode, and media file identifiers) that enable a playback device (e.g., the device 130) to retrieve and present some or all of the one or more excerpts determined in operation 840.

In operation 860, the response handler 250 causes the generated summary file from operation 850 to be provided to the device 130 of the user 132. The summary file may be provided as a full or partial response to the request that was detected in operation 810. According to various example embodiments, provision of the generated summary file to the device 130 causes the device 130 to present (e.g., play back) some or all of the summary file to the user 132.

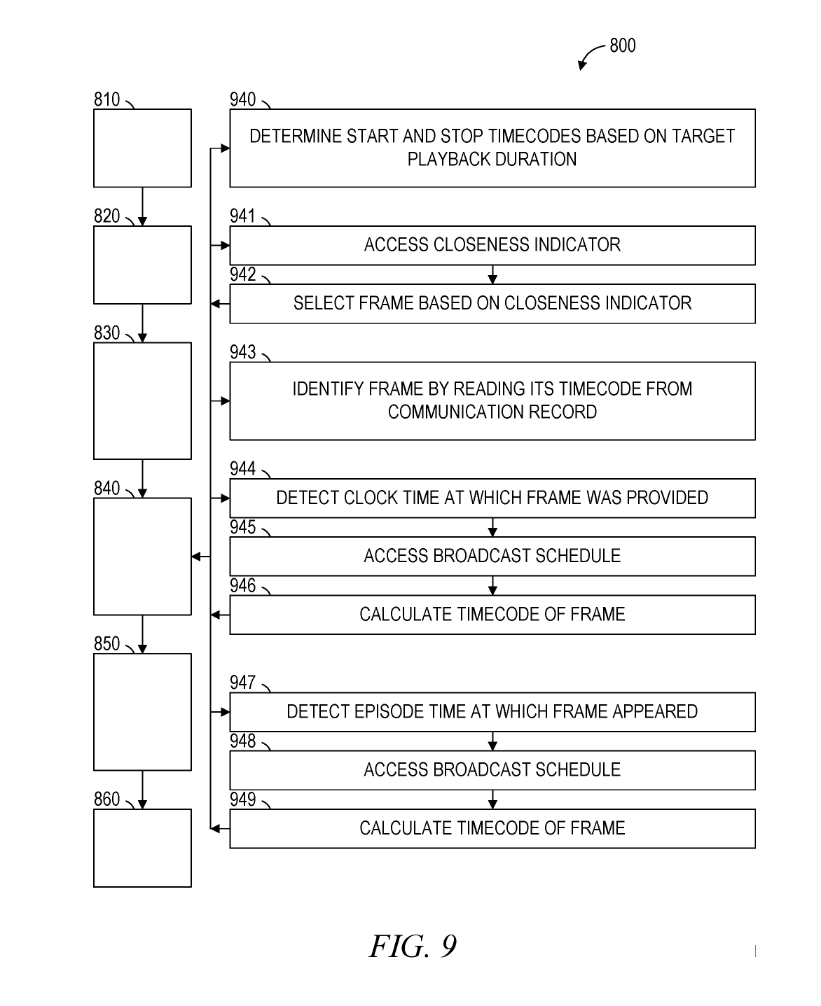

As shown in FIG. 9, various example embodiments of the method 800 may include one or more of operations 940, 941, 942, 943, 944, 945, 946, 947, 948, and 949, one or more of which may be performed as part (e.g., a precursor task, a subroutine, or a portion) of operation 840, in which the media summarizer 240, for example, determines the excerpt of the episode 311. In certain example embodiments, the request detected in operation 810 specifies (e.g., by inclusion) a duration (e.g., a target playback duration) of the summary file to be generated. In such situations, the media summarizer 240 performs operation 940 by determining the start timecode of the excerpt, the stop timecode of the excerpt, or both based on the duration specified in the request. For example, if only one episode (e.g., episode 311) is to be summarized, and thus only one excerpt is to be determined in operation 840, the start timecode and stop timecode of the excerpt are chosen by the media summarizer 240 to fit the duration specified in the request. As another example, if multiple episodes (e.g., episode 311, 312, and 313) are to be summarized, and thus multiple excerpts are to be determined, the start timecode and stop timecode of each excerpt are chosen by the media summarizer 240 to spend a portion of the requested duration (e.g., one third of the target playback duration).

In some example embodiments, the determination of the excerpt in operation 840 is based on social closeness between the user 132 and the user 142. Accordingly, operations 941 and 942 may be performed as part of operation 840. In operation 941, the media summarizer 240 accesses the closeness indicator 713 in the user profile 710 of the user 132. As noted above, the closeness indicator 713 may indicate (e.g., quantify) a degree of social closeness between the user 142 (e.g., as the sender of the communication referenced by the communication record 610) and the user 132 (e.g., as a friend of the sender). In operation 942, the media summarizer 240 selects the media frame (e.g., the referenced media frame) referenced by the portion of the records accessed in operation 830, based on the degree of social closeness indicated by the closeness indicator 713. According to various implementations, the communication record 610 is accorded additional influence (e.g., mathematical weight) if the sender (e.g., the user 142) of the corresponding communication is socially close (e.g., with maximum social closeness or minimum social distance) to the requesting user 132 (e.g., more likely to be a trusted family member or a friend with similar tastes in media content). Conversely, the communication record 610 may be accorded diminished influence if the sender (e.g., the user 142) of the corresponding communication is socially distant from the requesting user 132 (e.g., less likely to be trusted or to share similar tastes).

In certain example embodiments, the determination of the excerpt in operation 840 includes identifying the referenced media frame by its timecode within the media file (e.g., the media file 411) that stores the media frames of the episode (e.g., the episode 311) to be summarized. The timecode of the referenced media frame may be obtained in various ways. In some example embodiments, the timecode is present in the communication record 610 (e.g., as all or part of the reference 616 to the media frame), and the media summarizer 240 performs operation 943 to identify the referenced media frame. Specifically, in operation 943, the media summarizer 240 identifies the referenced media frame by reading its timecode directly from the communication record 610 (e.g., from the reference 616 in the sender comment 612).

Another way to identify the referenced media frame by its timecode is to calculate the timecode based on a clock time (e.g., within a standard time zone, such as Eastern Standard Time or Pacific Daylight Time) at which the referenced media frame was provided to the group 160 of users (e.g., a broadcast time at which the referenced media frame was provided to the devices 140 and 150). In such situations, such a clock time (e.g., a first clock time) is present in the communication record 610 (e.g., as all or part of the reference 616 to the media frame), and the media summarizer 240 performs operation 944 to detect the clock time. In particular, in operation 944, the media summarizer 240 reads the clock time (e.g., 6:23 PM Central Standard Time) from the communication record 610 (e.g., from the reference 616 in the sender comment 612).

The media summarizer 240 then performs operation 945, in which the media summarizer 240 accesses a broadcast schedule (e.g., from the media database 121 or another schedule database accessible via the network 190) that indicates a clock time (e.g., a second clock time) at which the beginning of the episode to be summarized (e.g., the episode 311) was provided to the group 160 of users (e.g., a starting broadcast time, such as 6:00 PM Central Standard Time, at which the beginning of the episode 311 was provided to the devices 140 and 150). Based on (e.g., in response to) the results of operations 944 and 945, the media summarizer 240 may perform operation 946 by calculating the timecode of the referenced media frame (e.g., calculating a time difference, such as 0:23:05 in hours-minutes-seconds format, between the second clock time at which the beginning of the episode was broadcast and the first clock time at which the referenced media frame was provided).

A further way to identify the referenced media frame by its timecode is to calculate the timecode based on an episode time (e.g., a first internal episode time, such as a game time as indicated by a game clock for a sports event) within the episode to be summarized (e.g., within the episode 311, the media file 411, or both) and at which the referenced media frame appeared to (e.g., was presented to or viewed by) the group 160 of users (e.g., a presentation time at which the referenced media frame was displayed by the devices 140 and 150). In such situations, such an episode time (e.g., a first episode time or a first game time) is present in the communication record 610 (e.g., as all or part of the reference 616 to the media frame), and the media summarizer 240 performs operation 947 to detect the episode time. Specifically, in operation 947, the media summarizer 240 reads the episode time (e.g., 0:09:00, in hours-minutes-seconds format, into a sports game, which may occur at 0:24:00, in hours-minutes-seconds format, from the beginning of the episode 311) from the communication record 610 (e.g., from the reference 616).

The media summarizer 240 next performs operation 948, in which the media summarizer 240 accesses a broadcast schedule (e.g., from the media database 121 or another schedule database) that maps another episode time (e.g., a second internal episode time or a second game time) within the episode (e.g., the episode 311) to a clock time (e.g., in a standard time zone). For example, the broadcast schedule may correlate the beginning of a sports game included in the episode 311 (e.g., 0:00:00 in hours-minutes-seconds format) with the clock time of 7:15 PM Central Standard Time, at which the beginning of the sports game was provided to the group 160 of users (e.g., via the devices 140 and 150).

Based on the results of operations 947 and 948, the media summarizer 240 may perform operation 949 by calculating the timecode of the referenced media frame based on the combination of the clock time and the two episode times (e.g., the first and second episode times or game times). For example, if the episode 311 began to be broadcast at 7:00 PM Central Standard Time, the sports game began at 7:15 PM Central Standard Time, and the communication record 610 indicates that the referenced media frame appeared at 0:09:00 (9 minutes) into the sports game, the media summarizer 240 may perform operation 949 by calculating the timecode of the referenced media frame as 0:24:00, in hours-minutes-seconds format, from the beginning of the episode 311.

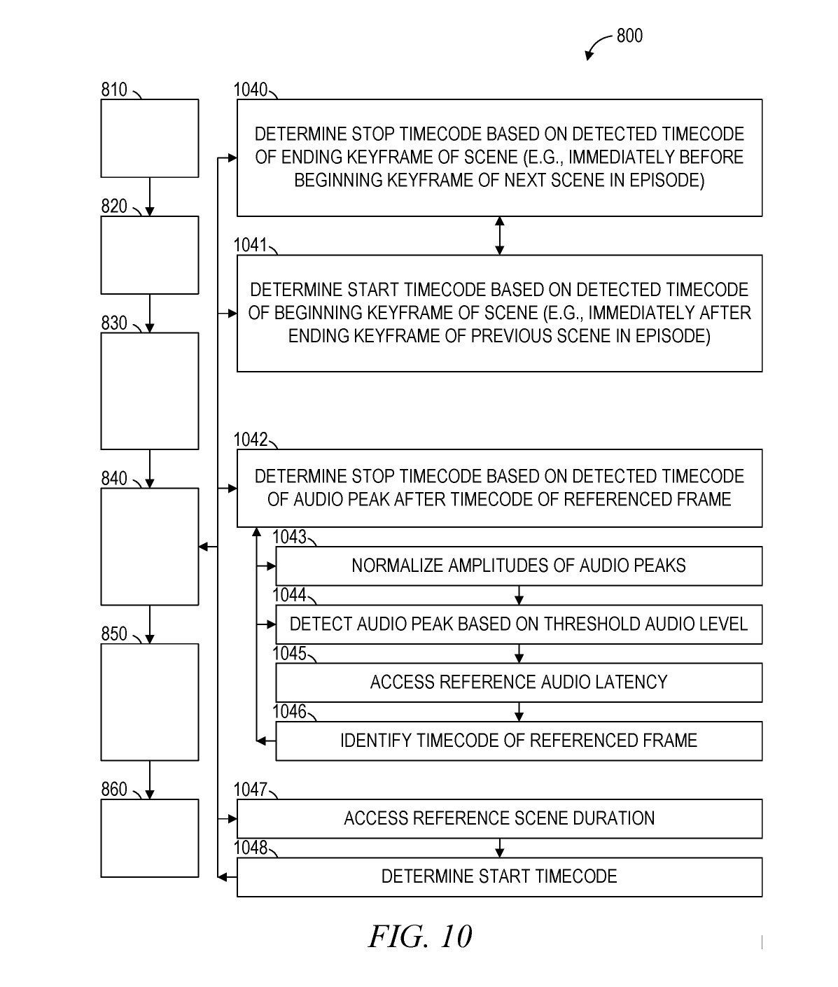

As shown in FIG. 10, some example embodiments of the method 800 may include one or more of operations 1040, 1041, 1042, 1043, 1044, 1045, 1046, 1047, and 1048. In particular, one or more of operations 1040-1048 may be performed as part of operation 840, in which the media summarizer 240, for example, determines the excerpt of the episode 311.

In some example embodiments, the stop timecode of the excerpt is determined based on a detected timecode of an ending keyframe of a scene that includes the referenced media frame. For example, the ending keyframe may occur immediately before a beginning keyframe of the next scene in the episode 311, and the media summarizer 240 may detect that these two keyframes occur sequentially (e.g., with sequential presentation timestamps or otherwise sequenced back-to-back) in the media file 411 for the episode 311. In some situations, the ending keyframe of the scene is a final media frame in one group-of-pictures (GOP) within the media file 411, while the beginning keyframe of the next scene is an initial media frame in the next GOP in the media file 411. Accordingly, the media summarizer 240 may perform operation 1040 by detecting the timecode of the ending keyframe that ends the media scene and then determining the stop timecode of the excerpt based on (e.g., equal to or offset by a predetermined time span from) the detected timecode of the ending keyframe.

In certain example embodiments, the start timecode of the excerpt is determined based on a detected timecode of a beginning keyframe of a scene that includes the referenced media frame. For example, the beginning keyframe may occur immediately after an ending keyframe of the preceding scene in the episode 311, and the media summarizer 240 may detect that these two keyframes occur sequentially (e.g., with sequential presentation timestamps or otherwise sequenced back-to-back) in the media file 411 for the episode 311. In certain situations, the beginning keyframe of the scene is an initial media frame in one GOP within the media file 411, while the ending keyframe of the preceding scene is a final media frame in the preceding GOP of the media file 411. Accordingly, the media summarizer 240 may perform operation 1041 by detecting a timecode of the beginning keyframe that begins the media scene and then determining the start timecode of the excerpt based on (e.g., equal to or offset by a predetermined time span from) the detected timecode of the beginning keyframe.

According to various example embodiments, the stop timecode of the excerpt is determined based on a timecode of a detected audio peak (e.g., indicative of applause, cheers, booing, crowd noise, or other reactionary sounds) present in one or more audio tracks of the episode to be summarized (e.g., the episode 311). For example, the referenced media frame may depict or otherwise present a noteworthy event (e.g., a significant goal scored by a celebrity athlete) in a sports game (e.g., basketball game or football game) within the episode to be summarized (e.g., within the episode 311, the media file 411, or both), and one or more audio tracks may capture a crowd reaction (e.g., a roaring sound) to the noteworthy event within a short time span (e.g., 0.5 seconds, 1 second, 2 seconds, or 5 seconds) after the referenced media frame. In such example embodiments, the media summarizer 240 performs operation 1042 by determining the stop timecode of the excerpt based on (e.g., equal to or offset by a predetermined time span from) the timecode of a detected audio peak that occurs after the timecode of the referenced media frame. As shown in FIG. 10, one or more of operations 1043, 1044, 1045, and 1046 may be performed as part of operation 1042.

In operation 1043, the media summarizer 240 normalizes the amplitudes of one or more audio peaks in the media file 411 (e.g., within one or more audio tracks stored in the media file 411). In situations where the average audio level of the media file 411 is non-constant (e.g., increases or decreases) over the duration of the episode 311, performance of operation 1043 may counteract or otherwise account for any overall increase or decrease in audio level (e.g., crowd noise being higher near the end of a basketball game than at the beginning of the basketball game).

In operation 1044, the media summarizer 240 detects an audio peak (e.g., a candidate audio peak) among multiple audio peaks (e.g., normalized in operation 1043) in the media file 411. This detection may be based on the audio peak transgressing (e.g., exceeding) a threshold audio level (e.g., a threshold minimum audio level). This detected audio peak can form a basis for determining the stop timecode in operation 1042.

In operation 1045, the media summarizer 240 accesses a reference audio latency (e.g., stored in the summarizer machine 110 or the media database 121). The reference audio latency (e.g., 0.5 seconds, 1 second, 2 seconds, 3 seconds, or 5 seconds) may represent an average or median time span between noteworthy events (e.g., goals or other significant plays in sports games of a particular type, such as basketball games or football games) and typical audio reactions by spectators who witnessed the noteworthy events (e.g., surges in applause, cheers, boos, or other crowd noise). This accessed audio latency can form a basis for determining the timecode of the referenced media frame, determining the stop timecode of the excerpt, or both.

In operation 1046, the media summarizer 240 identifies the timecode of the referenced media frame (e.g., as a basis for determining the stop timecode in operation 1042). In particular, the timecode of the referenced media frame can be identified in operation 1046 based on a timecode of the detected audio peak from operation 1044. This identification may further be based on the accessed audio latency from operation 1045.

According to some example embodiments, the start timecode of the excerpt is determined based on a reference scene duration (e.g., an expected or average scene duration), which may be used in conjunction with the timecode of the audio peak detected in operation 1044. Accordingly, in operation 1047, the media summarizer 240 accesses the reference scene duration (e.g., from the summarizer machine 110 or from the media database 121). The reference scene duration (e.g., 2 seconds, 3 seconds, 4 seconds, 5 seconds, 8 seconds, or 10 seconds) may represent an average or median scene length within the media series 300 or within one or more seasons thereof (e.g., season 310). This accessed reference scene duration can form a basis for determining the start timecode of the excerpt (e.g., based on the stop timecode of the excerpt).

In operation 1048, the media summarizer 240 determines the start timecode of the excerpt. As noted above, the start timecode may be determined based on the reference scene duration accessed in operation 1047. The determination of the start timecode may be further based on the stop timecode of the excerpt (e.g., from operation 1040 or operation 1042), the timecode of the referenced media frame (e.g., from operation 943, operation 946, or operation 949), or any suitable combination thereof. In some example embodiments, the media summarizer 240 also performs operation 940 to modify (e.g., adjust or update) the start timecode, the stop timecode, or both based on the target playback duration (e.g., specified in the request detected in operation 810).

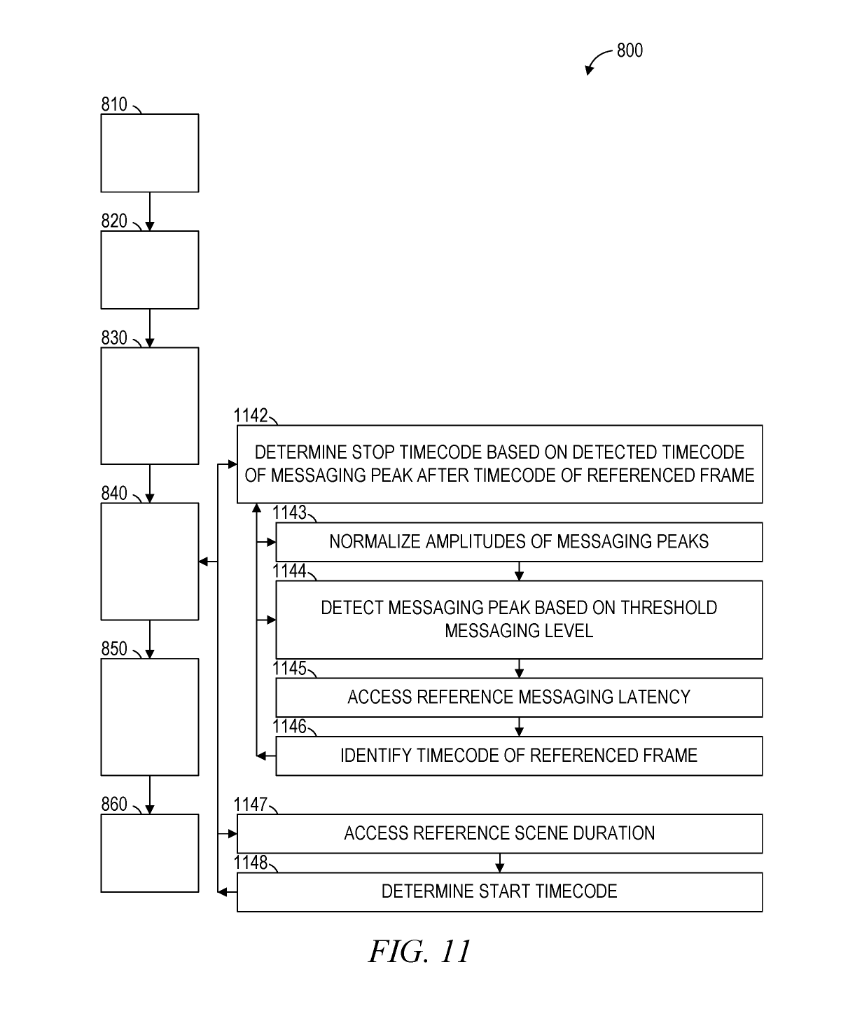

As shown in FIG. 11, some example embodiments of the method 800 may include one or more of operations 1142, 1143, 1144, 1145, 1146, 1147, and 1148. In particular, one or more of operations 1142-1148 may be performed as part of operation 840, in which the media summarizer 240, for example, determines the excerpt of the episode 311.

According to certain example embodiments, the stop timecode of the excerpt is determined based on a timecode of a detected messaging peak (e.g., indicative of likes, shares, upvotes, tweets, or other reactionary social media communications) in communications among various groups of users (e.g., the group 160, which includes the users 142 and 152) via the network 190. For example, the communications may be tracked by the communication database 126 (e.g., via communication records similar to the communications records 610 and 620), and one or more messaging peaks may be detected (e.g., by the communication database 126, the media summarizer 240, or both) with corresponding timecodes, during presentation of the episode to be summarized (e.g., the episode 311). For example, the referenced media frame may depict or otherwise present a noteworthy event (e.g., a significant goal scored by a celebrity athlete) in a sports game (e.g., basketball game or football game) within the episode to be summarized (e.g., within the episode 311, the media file 411, or both), and the communication database 126 may track a reaction (e.g., an increase in social media activity) to the noteworthy event within a short time span (e.g., 2 seconds, 5 seconds, 10 seconds, 15 seconds, 20 seconds, or 30 seconds) after the referenced media frame. In such example embodiments, the media summarizer 240 performs operation 1142 by determining the stop timecode of the excerpt based on (e.g., equal to or offset by a predetermined time span from) the timecode of a detected messaging peak that occurs after the timecode of the referenced media frame. As shown in FIG. 11, one or more of operations 1143, 1144, 1145, and 1146 may be performed as part of operation 1142.

In operation 1143, the media summarizer 240 normalizes the amplitudes of one or more messaging peaks detected (e.g., tracked) by the communication database 126, the media summarizer 240, or both. In situations where the average messaging level during the episode 311 is non-constant (e.g., increases or decreases), performance of operation 1143 may counteract or otherwise account for any overall increase or decrease in messaging level (e.g., social media activity being higher near the end of a basketball game than at the beginning of the basketball game).

In operation 1144, the media summarizer 240 detects a messaging peak (e.g., a candidate messaging peak) among multiple messaging peaks (e.g., normalized in operation 1143) during the episode 311. This detection may be based on the messaging peak transgressing (e.g., exceeding) a threshold messaging level (e.g., a threshold minimum messaging level). This detected messaging peak can form a basis for determining the stop timecode in operation 1142.

In operation 1145, the media summarizer 240 accesses a reference messaging latency (e.g., stored in the summarizer machine 110 or the communication database 126). The reference messaging latency (e.g., 2 seconds, 3 seconds, 5 seconds, 10 seconds, 15 seconds, 20 seconds, or 30 seconds) may represent an average or median time span between noteworthy events (e.g., goals or other significant plays in sports games of a particular type, such as basketball games or football games) and typical surges in reactive messaging activity by spectators who witnessed the noteworthy events (e.g., spikes in likes, shares, upvotes, tweets, or other social media messages). This accessed messaging latency can form a basis for determining the timecode of the referenced media frame, determining the stop timecode of the excerpt, or both.

In operation 1146, the media summarizer 240 identifies the timecode of the referenced media frame (e.g., as a basis for determining the stop timecode in operation 1142). In particular, the timecode of the referenced media frame can be identified in operation 1146 based on a timecode of the detected messaging peak from operation 1144. This identification may further be based on the accessed messaging latency from operation 1145.

According to various example embodiments, the start timecode of the excerpt is determined based on a reference scene duration (e.g., an expected or average scene duration), which may be used in conjunction with the timecode of the messaging peak detected in operation 1144. Accordingly, in operation 1147, the media summarizer 240 accesses the reference scene duration (e.g., from the summarizer machine 110 or from the media database 121). The reference scene duration (e.g., 2 seconds, 3 seconds, 4 seconds, 5 seconds, 8 seconds, or 10 seconds) may represent an average or median scene length within the media series 300 or within one or more seasons thereof (e.g., season 310). This accessed reference scene duration can form a basis for determining the start timecode of the excerpt (e.g., based on the stop timecode of the excerpt).

In operation 1148, the media summarizer 240 determines the start timecode of the excerpt. As noted above, the start timecode may be determined based on the reference scene duration accessed in operation 1147. The determination of the start timecode may be further based on the stop timecode of the excerpt (e.g., from operation 1040 or operation 1142), the timecode of the referenced media frame (e.g., from operation 943, operation 946, or operation 949), or any suitable combination thereof. In some example embodiments, the media summarizer 240 also performs operation 940 to modify (e.g., adjust or update) the start timecode, the stop timecode, or both based on the target playback duration (e.g., specified in the request detected in operation 810).

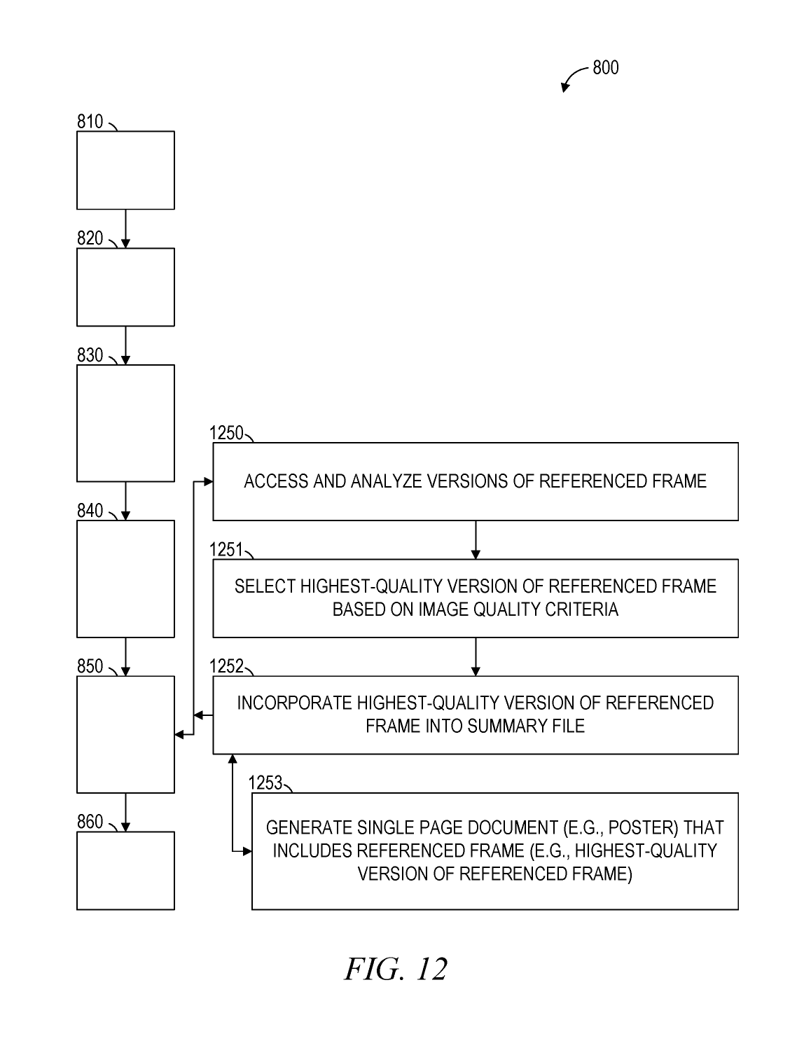

As shown in FIG. 12, some example embodiments of the method 800 may include one or more of operations 1250, 1251, 1252, and 1253. In particular, one or more of operations 1250-1253 may be performed as part of operation 850, in which the media summarizer 240 generates the summary file from one or more excerpts that include referenced media frames.

In operation 1250, the media summarizer 240 accesses the media database 121 to access multiple versions of an episode to be summarized (e.g., multiple versions of the media file 411 for the episode 311). The media summarizer 240 analyzes these multiple versions, determines a quality score for each version, and may rank the multiple versions. Each determined quality score may indicate or otherwise represent (e.g., specify or quantify) visual quality (e.g., video resolution, video frame rate, video compression type, video compression level, average bit rate, lack of noise, or any suitable combination thereof), audio quality (e.g., number of channels, sampling rate, audio compression type, audio compression level, average bit rate, lack of noise, or any suitable combination thereof), or both.

In operation 1251, the media summarizer 240 selects the highest-quality version of the referenced media frame (e.g., within the highest-quality version of the media file 411 for the episode 311). This selected version of the referenced media frame (e.g., along with additional media frames before and after the referenced media frame) can be included in the summary file to be generated (e.g., as a highest-quality version of the excerpt determined in operation 840).

Accordingly, in operation 1252, the media summarizer 240 incorporates the highest-quality version of the referenced media frame (e.g., along with additional media frames from the highest-quality version of the media file 411 for the episode 311) into the summary file be generated in operation 850. This may have the effect of providing the best available media content in the generated summary file.

As shown in FIG. 12, operation 1253 may be performed as part of operation 1252. In some example embodiments, the generated summary file is limited to a single-page document (e.g., a single image or a poster) that summarizes a requested episode (e.g., the episode 311). Thus, in operation 1253, the media summarizer 240 generates the single-page document, and the single-page document may be or include the referenced media frame (e.g., the highest-quality version of the referenced media frame, as determined in operation 1251).

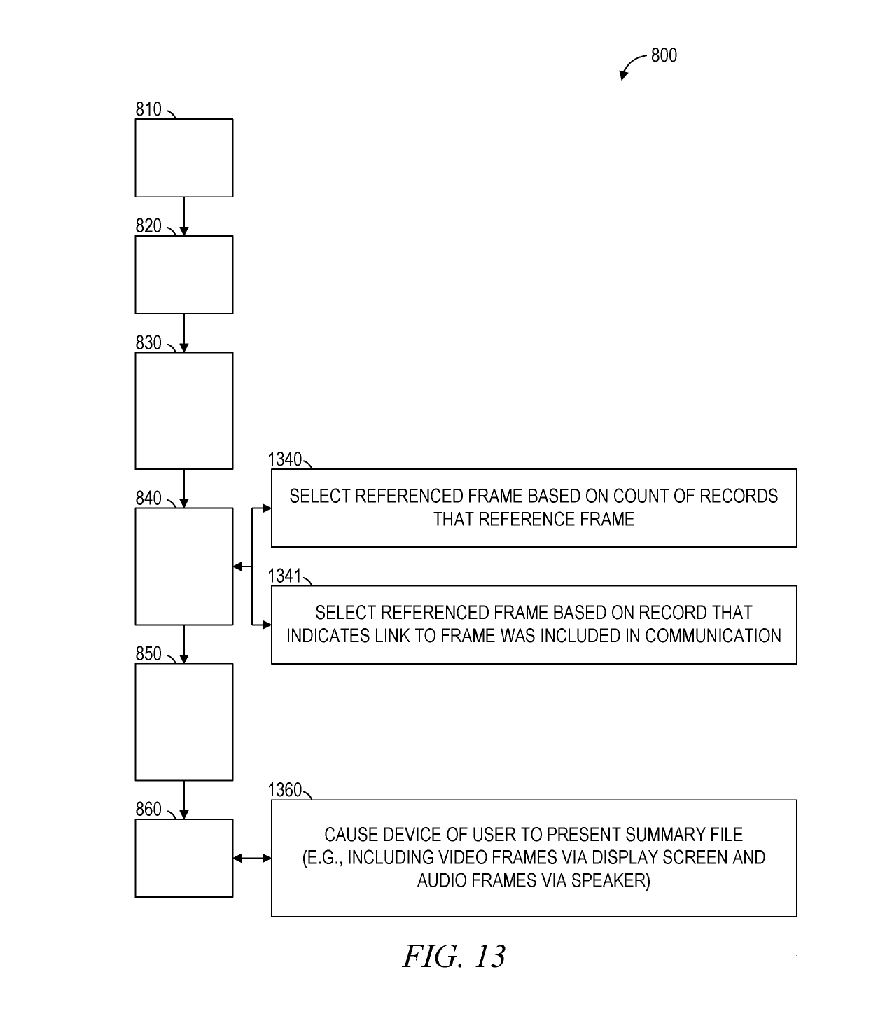

According to some example embodiments, the selection of the referenced media frame is based on the number of records (e.g., communications records, such as the communication records 610 and 620) that reference that media frame. Accordingly, as shown in FIG. 13, some example embodiments the method 800 may include one or more of operations 1340, 1341, and 1360. One or both of operations 1340 and 1341 may be performed as part of operation 840, in which the media summarizer 240 determines the excerpt of the episode to be summarized (e.g., the episode 311). In operation 1340, the media summarizer 240 selects the referenced media frame based on a count of communication records (e.g., communication records 610 and 620) that reference that media frame. This count of communication records may be accessed from the communication database 126 or calculated by the media summarizer 240 (e.g., based on search results requested and obtained from the communication database 126). As noted above, a portion of the records accessed in operation 830 identify the same media scene by virtue of referencing a same media frame (e.g., a same media frame that is referenced both by the reference 616 in the communication record 610 and by the reference 626 in the communication record 620). Thus, in some example embodiments, the count of communication records is equal to the size of the portion of the records accessed in operation 830.

According to certain example embodiments, if a communication record (e.g., communication record 610) indicates that a link to the media frame (e.g., a uniform resource locator (URL) to the media frame) was included in the corresponding communication, that communication is accorded special weight in the selection of the referenced media frame (e.g., as part of determining the excerpt in operation 840). Thus, in operation 1341, the media summarizer 240 selects the referenced media frame based on that communication record (e.g., communication record 610) indicating that the link was included in the corresponding communication (e.g., indicating that the URL to the media frame was sent from the user 142 to the user 152).

As also shown in FIG. 13, operation 1360 may be performed as part of operation 860, in which the response handler 250 provide the generated summary file to the device 130 of the user 132 who requested that the summary file be generated. In operation 1360, the response handler 250 causes the device 130 to present (e.g., display or otherwise play back) the generated summary file. This may include causing video frames to be displayed via a display screen of the device 130, causing audio frames to be played back via a speaker of the device 130, or both. In some example embodiments, the presentation of the generated summary file is initiated by the response handler 250 (e.g., by causing a prompt to be displayed to the user 132) but temporarily suspended until the user 132 indicates (e.g., by answering the prompt) that the presentation of the generated summary file is to proceed. In certain example embodiments, the providing of the summary file to the device 130 in operation 860 automatically triggers the device 130 to present the generated summary file.

According to various example embodiments, one or more of the methodologies described herein may facilitate generation and presentation of a summary (e.g., summary file) of one or more episodes (e.g., episodes 311-333) of a media series (e.g., media series 300). Moreover, one or more of the methodologies described herein may facilitate a convenient and abbreviated (e.g., shortened in time) presentation of noteworthy events in the media series. Hence, one or more of the methodologies described herein may facilitate an intuitive and humanly accessible form of video compression, as well as an intuitive and humanly accessible form of audio compression.

When these effects are considered in aggregate, one or more of the methodologies described herein may obviate a need for certain efforts or resources that otherwise would be involved in generation and presentation of a summary of media content, humanly accessible video compression, humanly accessible audio compression, or any suitable combination thereof. Efforts expended by a user in viewing media content, analyzing media scenes, and selecting media frames and excerpts of episodes for inclusion in a summary of the media series may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 14 is a block diagram illustrating components of a machine 1400, according to some example embodiments, able to read instructions 1424 from a machine-readable medium 1422 (e.g., a non-transitory machine-readable medium, a machine-readable storage medium, a computer-readable storage medium, or any suitable combination thereof) and perform any one or more of the methodologies discussed herein, in whole or in part. Specifically, FIG. 14 shows the machine 1400 in the example form of a computer system (e.g., a computer) within which the instructions 1424 (e.g., software, a program, an application, an applet, an app, or other executable code) for causing the machine 1400 to perform any one or more of the methodologies discussed herein may be executed, in whole or in part.

In alternative embodiments, the machine 1400 operates as a standalone device or may be communicatively coupled (e.g., networked) to other machines. In a networked deployment, the machine 1400 may operate in the capacity of a server machine or a client machine in a server-client network environment, or as a peer machine in a distributed (e.g., peer-to-peer) network environment. The machine 1400 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 1424, sequentially or otherwise, that specify actions to be taken by that machine. Further, while only a single machine is illustrated, the term “machine” shall also be taken to include any collection of machines that individually or jointly execute the instructions 1424 to perform all or part of any one or more of the methodologies discussed herein.

The machine 1400 includes a processor 1402 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof), a main memory 1404, and a static memory 1406, which are configured to communicate with each other via a bus 1408. The processor 1402 contains solid-state digital microcircuits (e.g., electronic, optical, or both) that are configurable, temporarily or permanently, by some or all of the instructions 1424 such that the processor 1402 is configurable to perform any one or more of the methodologies described herein, in whole or in part. For example, a set of one or more microcircuits of the processor 1402 may be configurable to execute one or more modules (e.g., software modules) described herein. In some example embodiments, the processor 1402 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 1400 with at least the processor 1402, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1400 may further include a graphics display 1410 (e.g., a plasma display panel (PDP), a light emitting diode (LED) display, a liquid crystal display (LCD), a projector, a cathode ray tube (CRT), or any other display capable of displaying graphics or video). The machine 1400 may also include an alphanumeric input device 1412 (e.g., a keyboard or keypad), a pointer input device 1414 (e.g., a mouse, a touchpad, a touchscreen, a trackball, a joystick, a stylus, a motion sensor, an eye tracking device, a data glove, or other pointing instrument), a data storage 1416, an audio generation device 1418 (e.g., a sound card, an amplifier, a speaker, a headphone jack, or any suitable combination thereof), and a network interface device 1420.

The data storage 1416 (e.g., a data storage device) includes the machine-readable medium 1422 (e.g., a tangible and non-transitory machine-readable storage medium) on which are stored the instructions 1424 embodying any one or more of the methodologies or functions described herein. The instructions 1424 may also reside, completely or at least partially, within the main memory 1404, within the static memory 1406, within the processor 1402 (e.g., within the processor's cache memory), or any suitable combination thereof, before or during execution thereof by the machine 1400. Accordingly, the main memory 1404, the static memory 1406, and the processor 1402 may be considered machine-readable media (e.g., tangible and non-transitory machine-readable media). The instructions 1424 may be transmitted or received over the network 190 via the network interface device 1420. For example, the network interface device 1420 may communicate the instructions 1424 using any one or more transfer protocols (e.g., hypertext transfer protocol (HTTP)).

In some example embodiments, the machine 1400 may be a portable computing device (e.g., a smart phone, a tablet computer, or a wearable device), and may have one or more additional input components 1430 (e.g., sensors or gauges). Examples of such input components 1430 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a biometric input component (e.g., a heartrate detector or a blood pressure detector), and a gas detection component (e.g., a gas sensor). Input data gathered by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1422 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1424 for execution by the machine 1400, such that the instructions 1424, when executed by one or more processors of the machine 1400 (e.g., processor 1402), cause the machine 1400 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 1424 for execution by the machine 1400 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 1424).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated embodiments describe various example embodiments of methods, machine-readable media, and systems (e.g., machines, devices, or other apparatus) discussed herein.

A first embodiment provides a method comprising:

detecting, using one or more processors, a request that a summary file be generated for a user, the request specifying a set of episodes of media content to be summarized by the summary file;
accessing, using the one or more processors, a media database that stores one or more media files that each store a different episode among the set of episodes to be summarized, each media file including media frames that each have a different timecode in the media file;
accessing, using the one or more processors, a communication database that stores records of communications among a group of users whose social relationships to the user are modeled by a social relationships database, the records each identifying a same media scene in a same episode among the set of episodes, a portion of the records each referencing a same media frame in the media scene in the episode;
determining, using the one or more processors, an excerpt of the media file that stores the episode, the excerpt including the referenced media frame and being defined by a start timecode and a stop timecode that surround a timecode of the referenced media frame in the media file;
generating, using the one or more processors, the summary file for the user, the summary file including the excerpt that includes the media frame referenced by each record in the portion of the records; and causing, using the one or more processors, the generated summary file to be provided to a device of the user in response to the request.

A second embodiment provides a method according to the first embodiment, wherein:

the request that the summary file be generated specifies a target playback duration of the summary file; and
the determining of the excerpt includes determining the start timecode and the stop timecode based on the target playback duration specified by the request.

A third embodiment provides a method according to the first embodiment or the second embodiment, wherein:

a record in the portion of the records indicates a communication by a sender among the group of users;
the method further comprises accessing an indicator from the social relationships database, the indicator quantifying a degree of closeness between the sender and the user; and
the determining of the excerpt includes selecting the referenced media frame for inclusion in the summary file based on the degree of closeness quantified by the indicator.

A fourth embodiment provides a method according to the third embodiment, wherein:

the indicator indicates a closest degree of closeness between the sender and the user; and
the selecting of the referenced media frame is based on the indicator indicating the closest degree of closeness.

A fifth embodiment provides a method according to any of the first through fourth embodiments, wherein:

the determining of the excerpt of the media file includes identifying the timecode of the referenced media frame by reading the timecode of the referenced media frame from a record in the portion of the records.

A sixth embodiment provides a method according to any of the first through fifth embodiments, wherein:

the determining of the excerpt of the media file includes identifying the timecode of the referenced media frame by:
detecting a first clock time at which the referenced media frame was provided to the group of users, the first clock time being detected by reading the first clock time from a record in the portion of the records;
accessing a broadcast schedule from a schedule database, the broadcast schedule indicating a second clock time at which a beginning of the episode was provided to the group of users; and
calculating the timecode of the referenced media frame within the media file based on a time difference between the first and second clock times.

A seventh embodiment provides a method according to any of the first through sixth embodiments, wherein:

the determining of the excerpt of the media file includes identifying the timecode of the referenced media frame by:
detecting a first episode time at which the referenced media frame appeared in the episode, the first episode time being detected by reading the first episode time from a record in the portion of the records;
accessing a broadcast schedule from a schedule database, the broadcast schedule mapping a second episode time of the episode to a clock time at which a beginning of the episode was provided to the group of users; and
calculating the timecode of the referenced media frame within the media file based on a combination of the clock time, the first episode time, and the second episode time.

An eighth embodiment provides a method according to any of the first through seventh embodiments, wherein:

the determining of the excerpt of the media file includes determining the stop timecode of the excerpt, the determining of the stop timecode including detecting a timecode of an ending keyframe that ends the media scene, the timecode of the ending keyframe immediately preceding a timecode of a beginning keyframe that begins a subsequent media scene in the episode, the determining of the stop timecode being based on the detected timecode of the ending keyframe that ends the media scene.

A ninth embodiment provides a method according to any of the first through eighth embodiments, wherein:

the determining of the excerpt of the media file includes determining the start timecode of the excerpt, the determining of the start timecode including detecting a timecode of a beginning keyframe that begins the media scene, the timecode of the beginning keyframe immediately following a timecode of an ending keyframe that ends a preceding media scene in the episode, the determining of the start timecode being based on the detected timecode of the beginning keyframe that begins the media scene.

A tenth embodiment provides a method according to any of the first through ninth embodiments, wherein:

the determining of the excerpt of the media file includes determining the stop timecode of the excerpt; the determining of the stop timecode including detecting a timecode of an audio peak subsequent to the timecode of the referenced media frame in the media file, the determining of the stop timecode being based on the detected timecode of the audio peak.

An eleventh embodiment provides a method according to the tenth embodiment, wherein:

the detecting of the timecode of the audio peak includes:
normalizing amplitudes of audio peaks in the media file; and
detecting the audio peak among the normalized amplitudes of the audio peaks based on a threshold audio level.

A twelfth embodiment provides a method according to the tenth embodiment or the eleventh embodiment, wherein:

the determining of the excerpt of the media file includes identifying the timecode of the referenced media frame, the identifying of the timecode of the referenced media frame including accessing a reference audio latency, the identifying of the timecode of the referenced media frame being based on the stop timecode of the excerpt and the reference audio latency.

A thirteenth embodiment provides a method according to the tenth through twelfth embodiments, wherein:

the determining of the excerpt of the media file includes determining the start timecode of the excerpt, the determining of the start timecode including accessing a reference scene duration, the determining of the start timecode being based on the reference scene duration and at least one of the stop timecode of the excerpt or the timecode of the referenced media frame.

A fourteenth embodiment provides a method according to any of the first through thirteenth embodiments, wherein:

the determining of the excerpt of the media file includes determining the stop timecode of the excerpt, the determining of the stop timecode including detecting a timecode of a messaging peak in the records, the determining of the stop timecode being based on the detected timecode of the messaging peak.

A fifteenth embodiment provides a method according to the fourteenth embodiment, wherein:

the detecting of the timecode of the messaging peak includes:
normalizing amplitudes of messaging peaks in the records; and detecting the messaging peak among the normalized amplitudes of the messaging peaks based on a threshold messaging level.

A sixteenth embodiment provides a method according to the fourteenth embodiment or the fifteenth embodiment, wherein:

the determining of the excerpt of the media file includes identifying the timecode of the referenced media frame, the identifying of the timecode of the referenced media frame including accessing a reference messaging latency, the identifying of the timecode of the referenced media frame being based on the stop timecode of the excerpt and the reference messaging latency.

A seventeenth embodiment provides a method according to any of the fourteenth through sixteenth embodiments, wherein:

the determining of the excerpt of the media file includes determining the start timecode of the excerpt, the determining of the start timecode including accessing a reference scene duration, the determining of the start timecode being based on the reference scene duration and at least one of the stop timecode of the excerpt or the timecode of the referenced media frame.

An eighteenth embodiment provides a method according to any of the first through seventeenth embodiments, wherein:

the generating of the summary file includes:
accessing and analyzing multiple versions of the referenced media frame;
selecting a highest-quality version of the referenced media frame based on a set of image quality criteria; and
incorporating the highest-quality version of the referenced media frame into the summary file.

A nineteenth embodiment provides a method according to any of the first through eighteenth embodiments, wherein:

the generating of the summary file generates a single-page document that includes the referenced media frame.

A twentieth embodiment provides a machine-readable medium (e.g., a non-transitory machine-readable storage medium) comprising instructions that, when executed by processors of a machine, cause the machine to perform operations comprising:

detecting a request that a summary file be generated for a user, the request specifying a set of episodes of media content to be summarized by the summary file;
accessing a media database that stores one or more media files that each store a different episode among the set of episodes to be summarized, each media file including media frames that each have a different timecode in the media file;
accessing a communication database that stores records of communications among a group of users whose social relationships to the user are modeled by a social relationships database, the records each identifying a same media scene in a same episode among the set of episodes, a portion of the records each referencing a same media frame in the media scene in the episode;
determining an excerpt of the media file that stores the episode, the excerpt including the referenced media frame and being defined by a start timecode and a stop timecode that surround a timecode of the referenced media frame in the media file;
generating the summary file for the user, the summary file including the excerpt that includes the media frame referenced by each record in the portion of the records; and
causing the generated summary file to be provided to a device of the user in response to the request.

A twenty-first embodiment provides a machine-readable medium according to the twentieth embodiment, wherein:

the determining of the excerpt of the media file includes selecting the referenced media frame for inclusion in the summary file based on a count of records in the portion of the records.

A twenty-second embodiment provides a machine-readable medium according to the twentieth embodiment or the twenty-first embodiment, wherein:

a record in the portion of the records references the media frame by indicating that a link to the referenced media frame was included in a communication by a sender among the group of users; and
the determining of the excerpt of the media file includes selecting the referenced media frame for inclusion in the summary file based on the record indicating that the link to the referenced media frame was included in the communication.

A twenty-third embodiment provides a machine-readable medium according to any of the twentieth through twenty-second embodiments, wherein:

the media frames in the media file include video frames; and
the causing of the generated summary file to be provided to the device of the user in response to the request causes the device to present the video frames to the user via a display screen of the device.

A twenty-fourth embodiment provides a system comprising:

one or more processors; and
a memory storing instructions that, when executed by the one or more processors of a machine, cause the one or more processors to perform operations comprising:

detecting a request that a summary file be generated for a user, the request specifying a set of episodes of media content to be summarized by the summary file;

accessing a media database that stores one or more media files that each store a different episode among the set of episodes to be summarized, each media file including media frames that each have a different timecode in the media file;

accessing a communication database that stores records of communications among a group of users whose social relationships to the user are modeled by a social relationships database, the records each identifying a same media scene in a same episode among the set of episodes, a portion of the records each referencing a same media frame in the media scene in the episode;

determining an excerpt of the media file that stores the episode, the excerpt including the referenced media frame and being defined by a start timecode and a stop timecode that surround a timecode of the referenced media frame in the media file;

generating the summary file for the user, the summary file including the excerpt that includes the media frame referenced by each record in the portion of the records; and

causing the generated summary file to be provided to a device of the user in response to the request.

A twenty-fifth embodiment provides a system according to the twenty-fourth embodiment, wherein:

the media frames in the media file include audio frames; and

the causing of the generated summary file to be provided to the device of the user in response to the request causes the device to present the audio frames to the user via an audio speaker of the device.

A twenty-sixth embodiment provides a carrier medium carrying machine-readable instructions for controlling a machine to carry out the operations of any one of the previously described embodiments.

What is claimed is:

1. A method comprising:
detecting, using one or more processors, a request that a summary file be generated for a user, the request specifying a set of episodes of media content to be summarized by the summary file;
accessing, using the one or more processors, a media database that stores one or more media files that each store a different episode among the set of episodes to be summarized, each media file including media frames that each have a different timecode in the media file;
accessing, using the one or more processors, a communication database that stores records of communications among a group of users whose social relationships to the user are modeled by a social relationships database, the records each identifying a same media scene in a same episode among the set of episodes, a portion of the records each referencing a same media frame in the media scene in the episode;
determining, using the one or more processors, an excerpt of the media file that stores the episode, the excerpt including the referenced media frame and being defined by a start timecode and a stop timecode that surround a timecode of the referenced media frame in the media file;
generating, using the one or more processors, the summary file for the user, the summary file including the excerpt that includes the media frame referenced by each record in the portion of the records; and
causing, using the one or more processors, the generated summary file to be provided to a device of the user in response to the request.

2. The method of claim 1, wherein:
the request that the summary file be generated specifies a target playback duration of the summary file; and
the determining of the excerpt includes determining the start timecode and the stop timecode based on the target playback duration specified by the request.

3. The method of claim 1, wherein:
a record in the portion of the records indicates a communication by a sender among the group of users;
the method further comprises accessing an indicator from the social relationships database, the indicator quantifying a degree of closeness between the sender and the user; and
the determining of the excerpt includes selecting the referenced media frame for inclusion in the summary file based on the degree of closeness quantified by the indicator.

4. The method of claim 3, wherein:
the indicator indicates a closest degree of closeness between the sender and the user; and
the selecting of the referenced media frame is based on the indicator indicating the closest degree of closeness.

5. The method of claim 1, wherein:
the determining of the excerpt of the media file includes identifying the timecode of the referenced media frame by reading the timecode of the referenced media frame from a record in the portion of the records.

6. The method of claim 1, wherein:
the determining of the excerpt of the media file includes identifying the timecode of the referenced media frame by:
detecting a first clock time at which the referenced media frame was provided to the group of users, the first clock time being detected by reading the first clock time from a record in the portion of the records;
accessing a broadcast schedule from a schedule database, the broadcast schedule indicating a second clock time at which a beginning of the episode was provided to the group of users; and
calculating the timecode of the referenced media frame within the media file based on a time difference between the first and second clock times.

7. The method of claim 1, wherein:
the determining of the excerpt of the media file includes identifying the timecode of the referenced media frame by:
detecting a first episode time at which the referenced media frame appeared in the episode, the first episode time being detected by reading the first episode time from a record in the portion of the records;
accessing a broadcast schedule from a schedule database, the broadcast schedule mapping a second episode time of the episode to a clock time at which a beginning of the episode was provided to the group of users; and
calculating the timecode of the referenced media frame within the media file based on a combination of the clock time, the first episode time, and the second episode time.

8. The method of claim 1, wherein:
the determining of the excerpt of the media file includes determining the stop timecode of the excerpt, the determining of the stop timecode including detecting a timecode of an ending keyframe that ends the media scene, the timecode of the ending keyframe immediately preceding a timecode of a beginning keyframe that begins a subsequent media scene in the episode, the determining of the stop timecode being based on the detected timecode of the ending keyframe that ends the media scene.

9. The method of claim 1, wherein:
the determining of the excerpt of the media file includes determining the start timecode of the excerpt, the determining of the start timecode including detecting a timecode of a beginning keyframe that begins the media scene, the timecode of the beginning keyframe immediately following a timecode of an ending keyframe that ends a preceding media scene in the episode, the determining of the start timecode being based on the detected timecode of the beginning keyframe that begins the media scene.

10. The method of claim 1, wherein:
the determining of the excerpt of the media file includes determining the stop timecode of the excerpt, the determining of the stop timecode including detecting a timecode of an audio peak subsequent to the timecode of the referenced media frame in the media file, the determining of the stop timecode being based on the detected timecode of the audio peak.

11. The method of claim 10, wherein:
the detecting of the timecode of the audio peak includes:
normalizing amplitudes of audio peaks in the media file; and
detecting the audio peak among the normalized amplitudes of the audio peaks based on a threshold audio level.

12. The method of claim 10, wherein:
the determining of the excerpt of the media file includes identifying the timecode of the referenced media frame, the identifying of the timecode of the referenced media frame including accessing a reference audio latency, the identifying of the timecode of the referenced media frame being based on the stop timecode of the excerpt and the reference audio latency.

13. The method of claim 10, wherein:
the determining of the excerpt of the media file includes determining the start timecode of the excerpt, the determining of the start timecode including accessing a reference scene duration, the determining of the start timecode being based on the reference scene duration and at least one of the stop timecode of the excerpt or the timecode of the referenced media frame.

14. The method of claim 1, wherein:
the determining of the excerpt of the media file includes determining the stop timecode of the excerpt, the determining of the stop timecode including detecting a timecode of a messaging peak in the records, the determining of the stop timecode being based on the detected timecode of the messaging peak.

15. The method of claim 14, wherein:
the detecting of the timecode of the messaging peak includes:
normalizing amplitudes of messaging peaks in the records; and
detecting the messaging peak among the normalized amplitudes of the messaging peaks based on a threshold messaging level.

16. The method of claim 14, wherein:
the determining of the excerpt of the media file includes identifying the timecode of the referenced media frame, the identifying of the timecode of the referenced media frame including accessing a reference messaging latency, the identifying of the timecode of the referenced media frame being based on the stop timecode of the excerpt and the reference messaging latency.

17. The method of claim 14, wherein:
the determining of the excerpt of the media file includes determining the start timecode of the excerpt, the determining of the start timecode including accessing a reference scene duration, the determining of the start timecode being based on the reference scene duration and at least one of the stop timecode of the excerpt or the timecode of the referenced media frame.

18. The method of claim 1, wherein:
the generating of the summary file includes:
accessing and analyzing multiple versions of the referenced media frame;
selecting a highest-quality version of the referenced media frame based on a set of image quality criteria; and
incorporating the highest-quality version of the referenced media frame into the summary file.

19. The method of claim 1, wherein:
the generating of the summary file generates a single-page document that includes the referenced media frame.

20. A non-transitory machine-readable storage medium comprising instructions that, when executed by processors of a machine, cause the machine to perform operations comprising:
detecting a request that a summary file be generated for a user, the request specifying a set of episodes of media content to be summarized by the summary file;
accessing a media database that stores one or more media files that each store a different episode among the set of episodes to be summarized, each media file including media frames that each have a different timecode in the media file;
accessing a communication database that stores records of communications among a group of users whose social relationships to the user are modeled by a social relationships database, the records each identifying a same media scene in a same episode among the set of episodes, a portion of the records each referencing a same media frame in the media scene in the episode;
determining an excerpt of the media file that stores the episode, the excerpt including the referenced media frame and being defined by a start timecode and a stop timecode that surround a timecode of the referenced media frame in the media file;
generating the summary file for the user, the summary file including the excerpt that includes the media frame referenced by each record in the portion of the records; and
causing the generated summary file to be provided to a device of the user in response to the request.

21. The non-transitory machine-readable storage medium of claim 20, wherein:
the determining of the excerpt of the media file includes selecting the referenced media frame for inclusion in the summary file based on a count of records in the portion of the records.

22. The non-transitory machine-readable storage medium of claim 20, wherein:
a record in the portion of the records references the media frame by indicating that a link to the referenced media frame was included in a communication by a sender among the group of users; and
the determining of the excerpt of the media file includes selecting the referenced media frame for inclusion in the summary file based on the record indicating that the link to the referenced media frame was included in the communication.

23. The non-transitory machine-readable storage medium of claim 20, wherein:
the media frames in the media file include video frames; and
the causing of the generated summary file to be provided to the device of the user in response to the request causes the device to present the video frames to the user via a display screen of the device.

24. A system comprising:
one or more processors; and
a memory storing instructions that, when executed by the one or more processors of a machine, cause the one or more processors to perform operations comprising:
detecting a request that a summary file be generated for a user, the request specifying a set of episodes of media content to be summarized by the summary file;
accessing a media database that stores one or more media files that each store a different episode among the set of episodes to be summarized, each media file including media frames that each have a different timecode in the media file;
accessing a communication database that stores records of communications among a group of users whose social relationships to the user are modeled by a social relationships database, the records each identifying a same media scene in a same episode among the set of episodes, a portion of the records each referencing a same media frame in the media scene in the episode;
determining an excerpt of the media file that stores the episode, the excerpt including the referenced media frame and being defined by a start timecode and a stop timecode that surround a timecode of the referenced media frame in the media file;
generating the summary file for the user, the summary file including the excerpt that includes the media frame referenced by each record in the portion of the records; and
causing the generated summary file to be provided to a device of the user in response to the request.

25. The system of claim 24, wherein:
the media frames in the media file include audio frames; and
the causing of the generated summary file to be provided to the device of the user in response to the request causes the device to present the audio frames to the user via an audio speaker of the device.
